(19) United States
(12) Patent Application Publication
(10) Pub. No.: US 2007/0120419 A1
(43) Pub. Date: May 31, 2007

(54) Hydro-pnemuatic mechanic device for the exploitation of the wave motion

(76) Inventor: Antonio Marchetti, Roma (IT)

Correspondence Address: YOUNG & THOMPSON, 745 SOUTH 23RD STREET, 2ND FLOOR, ARLINGTON, VA, 22202, US

(21) Appl. No.: 10/574,347

(22) PCT Filed: Sep. 28, 2004
(86) PCT No.: PCT/IT04/00531

§ 371 Date: Apr. 3, 2006

(30) Foreign Application Priority Data
Oct. 3, 2003 (IT) RM2003A000455

(51) Int. Cl. B60T 8/34

(52) U.S. Cl. 303/127

(57) ABSTRACT

A hydro-pneumatic mechanic device for the exploitation of the wave motion for obtaining renewable and ecological energy, comprising a series of submerged cylinders, placed onto wharfs fixed to the ground or onto floating pontoons or similar, provided in their lower part with a conic opening for the water inlet and in the upper part, with conical, spherical or plain shapes with lateral openings, respectively for producing compressed air, pumping water or generating mechanic energy.

The present invention concerns a hydro-pneumatic mechanic device for the exploitation of the wave motion for obtaining renewable and ecological energy.

The present invention comprises a series of six submerged cylinders, placed on wharfs fixed to the ground, on floating pontoons or on structures which allow the immersion thereof at a depth necessary for optimizing the efficiency of the system, according to the intensity of the wave motion, provided, in their lower part, with a conical opening for the water inlet and, in their upper part, with conical, spherical or plain shapes with lateral openings, respectively for producing compressed air, pumping water or generating mechanic energy.

The advantages of the device according to the present invention consist in the minimal environmental impact, in obtaining renewable energy and in the simplicity of said structures.

The present invention will be described more in detail hereinbelow relating to the enclosed drawings in which some embodiments are shown.

FIG. 1 shows a variant of the hydro-penumatic mechanic device for the exploitation of the wave motion according to the present invention, comprising a spherical head for the production of compressed air.

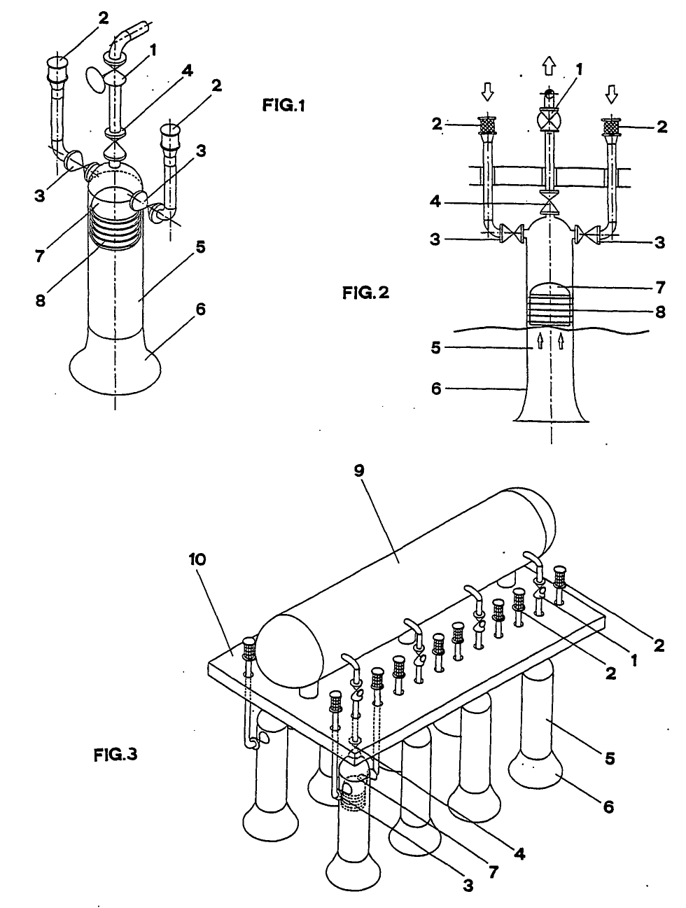

FIG. 2 shows a front view of the device according to the present invention.

FIG. 3 shows the device according to above mentioned variant, comprising a reservoir 9 for the collection of the air, and mounted on a wharf 10, fixed to the ground, floating or at controlled immersion.

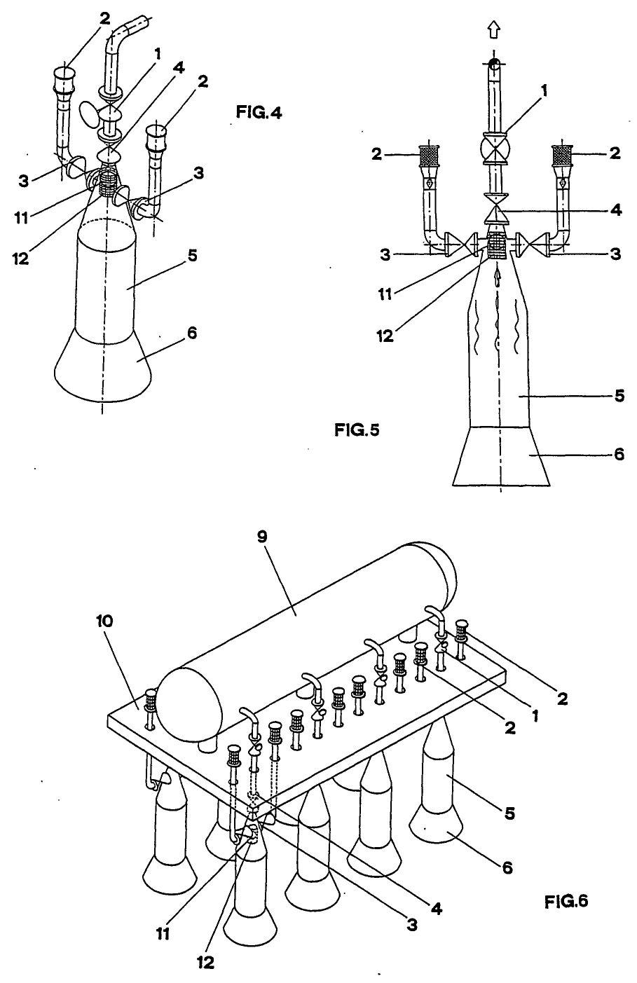

FIG. 4 shows a variant with a conical head for the production of compressed air, while FIG. 5 shows a front view of the device according to the present invention.

FIG. 6 shows the device according to the variant shown in FIGS. 4 and 5, comprising a reservoir 9 for the air collection, mounted on a wharf 10, fixed to the ground, floating or at controlled immersion.

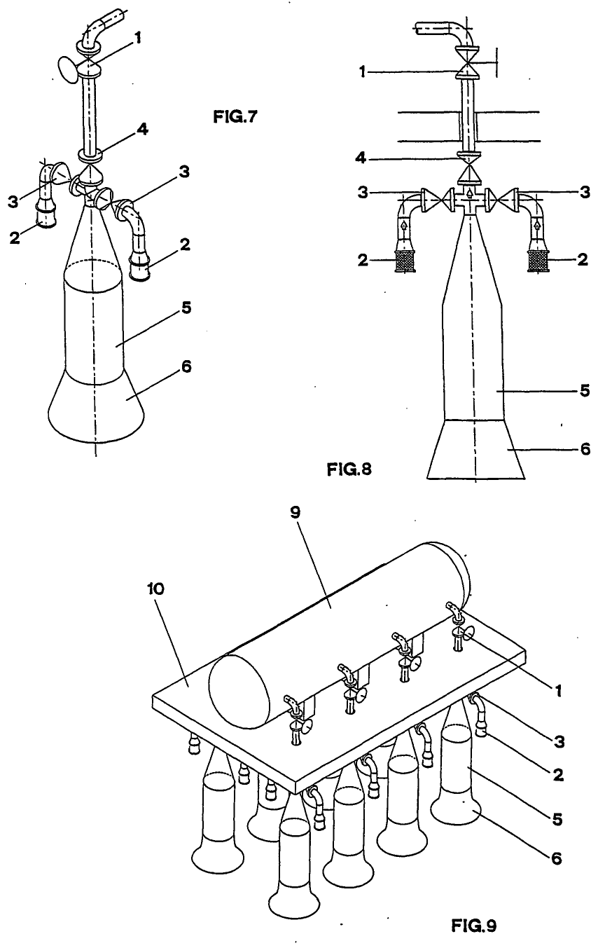

FIG. 7 shows a variant with a conical head for pumping water into collection basins or reservoirs, while FIG. 8 shows a front view. In FIG. 9, said variant shown in FIGS. 7 and 8 comprises the reservoir 9 for the water collection, mounted onto a floating wharf 10.

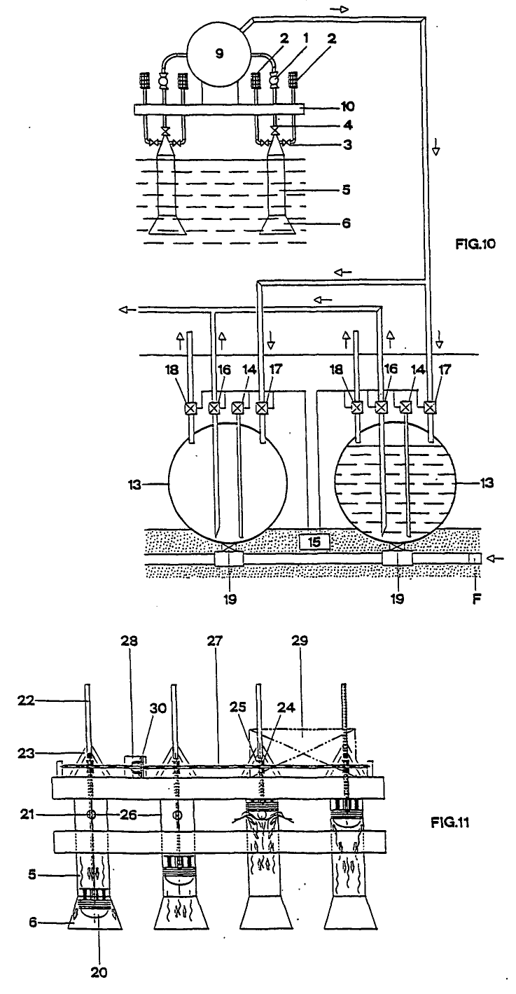

FIG. 10 shows an embodiment of the device for the production of compressed air.

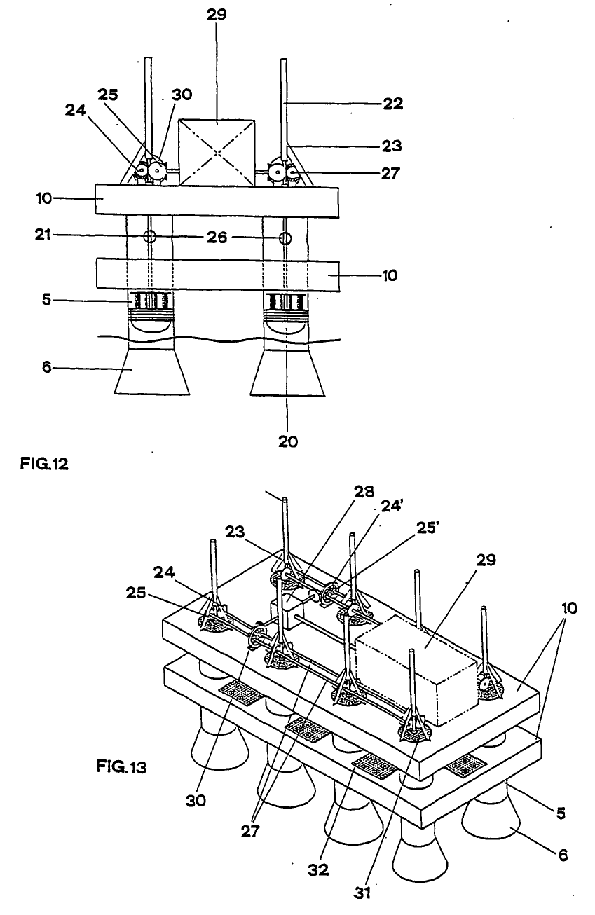

FIGS. 11, 12 and 13 show a variant of the device for the transformation of the wave motion into mechanical energy.

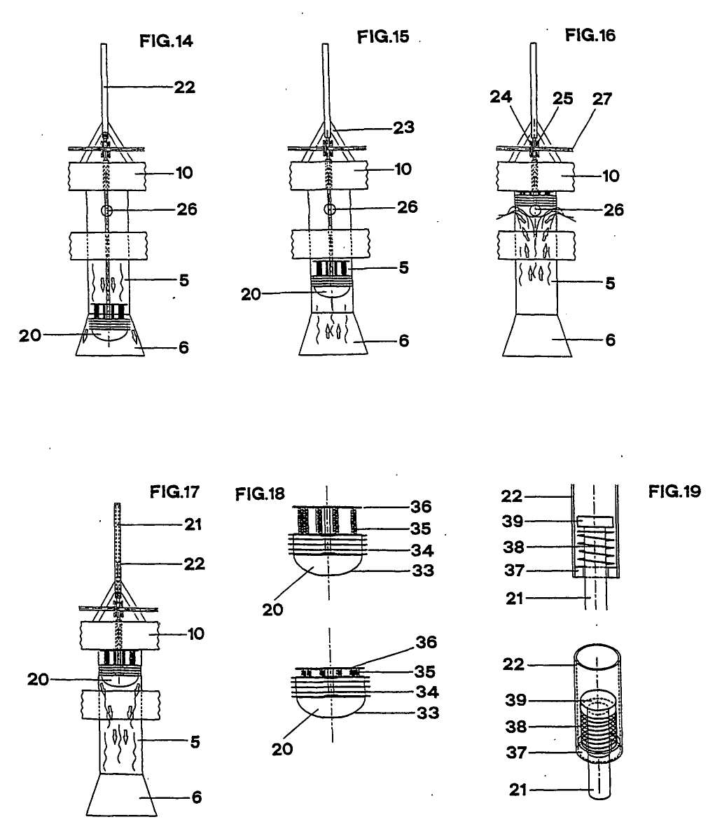

FIGS. 14, 15, 16 and 17 show the four main phases of the cylinders forming the system.

FIG. 18 shows the shock-absorbing means of a possible floating piston 20, in case of release and compression.

FIG. 19 shows a lateral section and axonometric and transparency view of the detail of the end of stroke system of a transmission shaft.

FIG. 20 shows a front, lateral and axonometric view of the system that collects the motion of the distribution rods for transferring the motion to the differential.

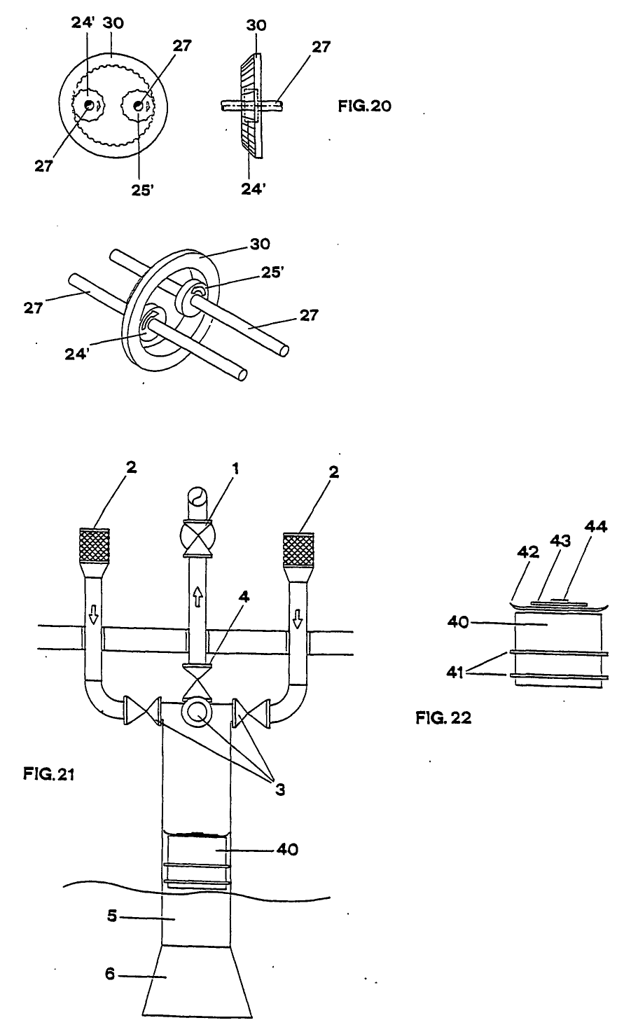

FIG. 21 shows a lateral view of a variant with a plain head for the production of compressed air, while FIG. 22 shows the shape of the floating pistons for the working of said plain head.

The enclosed figures show a hydro-pneumatic mechanic device for the exploitation of the wave motion according to the present invention for obtaining renewable and ecological energy, comprising:
a sluice-gate 1, hand operated, for closing the passage of the air from the cylinder to the collection and distribution system, so as to be able to act in case of servicing;
a plurality of filters 2 placed on the air inlet pipes;
unidirectional valves 3 which allow the inlet of the air into the cylinder, but not the outlet;
a unidirectional valve 4 which allows the passage of the air from the cylinder to the collection and distribution system, but not the inverse passage;
a body 5 of the cylinder;
a cone 6 for the inlet to the cylinder, which determines an increase of the water inside said cylinder according to its width and length;
a floating piston 7 with a semispheric head which, pushed by the water, compresses the air onto the semispheric head of the cylinder;
a plurality of bands 8 for sealing the floating piston.

The working of the hydro-pneumatic mechanic device for the exploitation of the wave motion for obtaining renewable and ecological energy according to the present invention may be described as follows:
the water entering said cylinder 5 due to the wave motion from the inlet cone 6, pushes said piston 7 towards the spherical head of said cylinder so that the air inside will get compressed towards the outlet of said cylinder, opening the unidirectional valve 4 and transferring the air towards the collection and distribution system;
when the wave lowers, the piston is called back downwards and said valve 4 closes, thus preventing the outlet of the collected air, and valves 3 open favouring the inlet of fresh air cleaned by filters 2, inside said cylinder, the sealing whereof is guaranteed by said bands 8 on the piston.

Relating to the variant with the conical head for the production of compressed air, shown in FIGS. 4 and 5, the following details are shown besides those already mentioned:
a floating shpere 11 for closing the water inlet, so as to allow the sole inlet of air;
a cage 12 for the sealing of said shpere,
   so that the water of the wave motion enters said cylinder 5 from said inlet cone 6 receiving a pressure that pushes the air in the cylinder towards said conical head and opening said valve 4 so as to send the air towards the collection and distribution system; when the water has reached the uppermost point of said cone, the floating shpere 11 closes the outlet of said cylinder, blocking a renewed rise; when the wave lowers, the depression closes said valve 4, avoiding the outlet of the collected air, and said valves 3 open, favouring the inlet of fresh air cleaned in said cylinder.

For what concerns the variant with conical head for pumping water into collection basins or reservoirs, shown in FIGS. 7, 8 and 9, said cylinder is completely submerged in the water so as to exploit at the maximum the compression and decompression action determined by the wave motion inside the same, and the pressure of the wave opens said unidirectional valve 4 transferring the water towards the collection basin or reservoir; when the wave lowers, the depression closes said valve 4 avoiding the outlet of the collected water, and valves 3 open favouring the inlet of fresh water inside said cylinder and reducing the previously generated pressure.

In the variant according to FIG. 10, the reservoirs are placed below the sea level and they are filled due to the phenomenon of the communicating vessels, using underground pipes provided with filters F for avoiding the inlet of deposits and impurities. The compressed air, produced by one of the hydro-pneumatic mechanic systems according to the present invention, will be let in, for sending the water to the electric turbines; the air let in said reservoirs 13 creates the pressure necessary for the outlet of the water through a pipe that will serve the users or the electric turbines; when the water level is near to nul, the level gauge 14 inside the reservoir sends a signal to an electronic panel 15 for the control of the closing of the valve 16 of the water for the users and of the valve 17 for the inlet of compressed air; in the same time it opens valves 16 and valve 17 for the inlet of compressed air in the next reservoir.

While the reservoir is working, the central panel will contemporarily open the exhaust valve 18 and valve 19 for filling said reservoir 13; when the latter is filled again, the level gauge 14 will send a new closing signal to said valves 16 and 17. With this variant, comprising two reservoirs 13, and adjusting the opening diameter for the water inlet and outlet, a continuous cycle for the water distribution is obtained, emptying one reservoir while filling the other. If a greater flow to the users is needed, the present invention provides a plurality of reservoirs.

In the variant of the device for transforming the wave motion into mechanic energy, shown in FIGS. 11, 12, 13, 14, 15, 16 and 17, the following additional elements are shown:
a floating piston 20;
a toothed rod 21 for the transmission of the movement to the gearing;
a guide 22 for the sliding of he transmission shaft;
a plurality of supports 23 for the guide of the shaft;
a unidirectional gear 24 for each ascending phase;
a unidirectional gear 25 for each descending phase;
a plurality of outlet openings 26 for excess water;
a plurality of shafts 27 for the distribution of the mechanical motion;
a differential 28;
one or more users 29;
a gear 20 for the transmission of the transmission shafts;
a plurality of grills 31 for the water outlet;
a plurality of grills 32 for water drainage.

The floating piston 20, shown in detail in FIG. 18, further comprises:
a hemispherical floating bottom 33;
a plurality of sealing bands 34;
a plurality of shock absorbing elements 35;
a head 36.

In the variant according to FIG. 19, the elements of the end of stroke device for shaft 21 are shown:
a ring 37 for the end of the stroke of the sliding guide 22;
a shock absorbing system 38;
a ring 39 for sealing the shock absorbing system.

As far as the device is concerned collecting the motion of the distribution shafts 27 for transferring the same to said differential 28—as shown in FIG. 20—the following elements are also shown:
a pair of unidirectional gears 24′ and 25′;
shafts 27 for the distribution of the motion;
a gear 30 for the transmission of the motion of the shafts to the differential.

This variant comprises a series of cylinders; when the wave passes, the water enters the cylinder from the inlet cone 6 and receives such a pressure as to push upwards said piston 20 connected to a toothed rod 21 which operates gears 24; when the wave lowers, it creates a depression such as to suck the piston downwards; in its descending phase, the toothed rod 21 operates said gear 25.

The motion is transmitted from said rod 21 to said distribution shafts 27; when the rod rises, the gear 24 puts into rotation its distribution shaft, while gear 25 turns idle, without operating its own shaft 27; when the shaft 21 comes down, the inverse happens and the gear 25 puts into rotation its own distribution shaft 27, while gear 24 turns idle; the movement of the two shafts is transformed into one single direction by said gear 30 and transmitted to said differential 28.

The device according to the present invention consists of a plurality of cylinders and allows to the transmission of the differential a continuous motion.

The device according to the present invention collects any wave motion; in case of rough sea, the cylinder has been provided with openings 26 for the water exhaust which will get open when the shock absorbing system 35 on the head 36 of the piston gets squeezed.

A system is also provided for absorbing heavy pushes and opening the water discharge openings 26 and, when the wave lowers again, pushing said piston 20 downwards for closing said openings so that he depression inside the cylinder drags the piston on the ground with force.

If the depression caused by the wave is too strong, a end of stroke system, shown in FIG. 19, is provided for avoiding the outlet of the shaft-piston 21-21, provided with a shock absorbing element for attenuating the blow. Furthermore, the inlet cone 6 will allow the passage of the air, annulling the depression created by the descending wave, as shown in FIG. 17.

The variant with plain head shown in FIG. 21 for the production of compressed air, has a greater number of unidirectional valves 3: this solution may be applied also to the preceding variants for easing the inlet of air or water into the cylinder and increasing the total efficiency of the system; said cylinder houses a floating piston 40 with cylindrical shape, shown in a lateral scheme in FIG. 22, provided with sealing bands 41 and with a special flexible gasket 42, fixed to the top of said piston by means of a blocking plate 43 provided with screw bolts 44, so as to prevent the formation inside said cylinder 5 of air pockets that might reduce the efficiency of he system.

For what concerns the working of this latter variant, the water entering inside said cylinder 5 through said inlet cone 6 due to the wave motion, pushes the piston 40 upwards compressing, by means of the action of the flexible gasket 42 of said piston 40, all of the air present in the cylinder towards the plain head of the same, thus preventing the forming of air bags inside until the opening of the unidirectional valve 4 is obtained, for transferring the air towards the special collection and distribution system.

When the wave lowers, said piston 40 is recalled downwards, being favoured in the movement by the flexibility of said gasket 42, causing the closing of said unidirectional valve 4 and the contemporary opening of said valves 3 for the inlet of fresh air cleaned by special filters 2 inside said cylinder 5, the sealing whereof is assured by bands 41 provided on said floating cylinder 40.

1. A hydro-pneumatic mechanic device for the exploitation of the wave motion for obtaining renewable and ecological energy, characterized in a series of submerged cylinders placed onto wharfs fixed to the ground or onto floating pontoons or similar, provided in their lower part with a conical opening for the water inlet and in their upper part with conical, spherical or plain shapes with lateral openings, for respectively producing compressed air, pumping water or generating mechanic energy, comprising:
a sluice-gate (1), hand operated, for closing the passage of the air from the cylinder to the collection and distribution system, so as to be able to act in case of servicing;
a plurality of filters (2) placed on the air inlet pipes;
unidirectional valves (3) which allow the inlet of the air into the cylinder, but not the outlet;
a unidirectional valve (4) which allows the passage of the air from the cylinder to the collection and distribution system, but not the inverse passage;
a body (5) of the cylinder;
a cone (6) for the inlet to the cylinder, which determines an increase of the water inside said cylinder according to its width and length;
a floating piston (7) with a semispheric head which, pushed by the water, compresses the air onto the semispheric head of the cylinder;
a plurality of bands (8) for sealing the floating piston, so that the water entering said cylinder (5) due to the wave motion from the inlet cone (6), pushes said piston (7) towards the spherical head of said cylinder so that the air inside will get compressed towards the outlet of said cylinder, opening the unidirectional valve (4) and transferring the air towards the collection and distribution system, and when the wave lowers, said piston is called back downwards and said valve (4) closes, thus preventing the outlet of the collected air, and valves (3) open favouring the inlet of fresh air cleaned by filters (2), inside said cylinder, the sealing whereof is guaranteed by said bands (8) on the piston.

2. A device according to claim 1, of the kind with a conical head for the production of compressed air, characterized in:
a floating shpere (11) for closing the water inlet, so as to allow the sole inlet of air;
a cage (12) for the sealing of said shpere,
so that the water of the wave motion enters said cylinder (5) from said inlet cone (6) receiving a pressure that pushes the air in the cylinder towards said conical head and opening said valve (4) so as to send the air towards the collection and distribution system; when the water has reached the uppermost point of said cone, the floating shpere (11) closes the outlet of said cylinder, blocking a renewed rise; when the wave lowers, the depression closes said valve (4), avoiding the outlet of the collected air, and said valves (3) open, favouring the inlet of fresh air cleaned in said cylinder.

3. A device according to claim 1, of the kind with a conical head for the production of compressed air, characterized in:
a floating shpere (11) for closing the water inlet, so as to allow the sole inlet of air;
a cage (12) for the sealing of said shpere,
so that the water of the wave motion enters said cylinder (5) from said inlet cone (6) receiving a pressure that pushes the air in the cylinder towards said conical head and opening said valve (4) so as to send the air towards the collection and distribution system; when the water has reached the uppermost point of said cone, the floating shpere (11) closes the outlet of said cylinder, blocking a renewed rise; when the wave lowers, the depression closes said valve (4), avoiding the outlet of the collected air, and said valves (3) open, favouring the inlet of fresh air cleaned in said cylinder.

4. A device according to claim 1, characterized in that the reservoirs (13) are placed below the sea level and that they are filled due to the phenomenon of the communicating vessels and that air, compressed at a pressure necessary to the water outlet through a pipe that will serve the users or the electric turbines, is let in, while when the water level is near to nul, the level gauge (14) inside the reservoir sends a signal to an electronic panel (15) for the control of the closing of the valve (16) of the water for the users and of the valve (17) for the inlet of compressed air and, at the same time, it opens valves (16) and valve (17) for the inlet of compressed air in the next reservoir (13), so that while the reservoir is working, the central panel will contemporarily open the exhaust valve (18) and valve (19) for filling said reservoir (13) and when the latter is filled again, the level gauge (14) will send a new closing signal to said valves (16 and 17).

5. A device according to claim 4, characterized in that with two reservoirs 13, and adjusting the opening diameter for the water inlet and outlet, a continuous cycle for the water distribution is obtained, emptying one reservoir while filling the other.

6. A device according to claim 1, of the kind for transforming the wave motion into mechanic energy, characterized in:
a floating piston (20);
a toothed rod (21) for the transmission of the movement to the gearing;
a guide (22) for the sliding of he transmission shaft;
a plurality of supports (23) for the guide of the shaft;
a unidirectional gear (24) for each ascending phase;
a unidirectional gear (25) for each descending phase;
a plurality of outlet openings (26) for excess water;
a plurality of shafts (27) for the distribution of the mechanical motion;
a differential (28);
one or more users (29);
a gear (30) for the transmission of the transmission shafts;
a plurality of grills (31) for the water outlet;
a plurality of grills (32) for water drainage.

7. A device according to claim 6, characterized in a floating piston 20 comprising:
a hemispherical floating bottom (33);
a plurality of sealing bands (34);
a plurality of shock absorbing elements (35);
a head (36).

8. A device according to claim 1, characterized in an end of stroke device for shaft (21) comprising:
a ring (37) for the end of the stroke of the sliding guide (22);
a shock absorbing system (38);
a ring (39) for sealing the shock absorbing system.

9. A device according to claim 1, characterized in a means for collecting the motion of the distribution shafts (27) for transferring the same to said differential (28), comprising:
a pair of unidirectional gears (24′) and (25′);
shafts (27) for the distribution of the motion;
a gear (30) for the transmission of the motion of the shafts to the differential.

10. A device according to claim 9, characterized in a series of cylinders so that, when the wave passes, the water enters the cylinder from the inlet cone (6) and receives such a pressure as to push upwards said piston (20) connected to a toothed rod (21) which operates gears (24), and when the wave lowers, it creates a depression such as to suck the piston downwards while in its descending phase, the toothed rod (21) operates said gear (25) and the motion is transmitted from said rod (21) to said distribution shafts (27) so that, when the rod rises, the gear (24) puts into rotation its distribution shaft while gear (25) turns idle, without operating its own shaft (27), and when shaft (21) comes down, the inverse happens and the gear (25) puts into rotation its own distribution shaft (27), while gear (24) turns idle; the movement of the two shafts (27) is transformed into one single direction by said gear (30) and transmitted to said differential (28).

11. A device according to claim 1, characterized in a shock absorbing means for absorbing violent pushes and opening discharge openings (26) for the water and, when the wave lowers, pushing said piston (20) downwards for closing the openings so that the depression inside the cylinder drags with force the piston to the ground.

12. A device according to claim 11, characterized in an end of stroke means, provided with a shock absorbing means for absorbing the violent pushes of the waves.

13. A device according to claim 1, of the kind with a plain head for the production of compressed air, characterized in an increased number of unidirectional valves (3) for favouring the inlet of the air into said cylinder (5), inside which a floating piston (40) is housed with cylindrical shape, provided with sealing bands e with a flexible gasket (42), fixed to its upper part by means of a blocking plate (43) with screw bolts (44) for preventing the forming, inside said cylinder (5), of air bags reducing the efficiency.
